(19) United States
(12) Patent Application Publication
(10) Pub. No.: US 2014/0233223 A1
(43) Pub. Date: Aug. 21, 2014

(54) Wall or picture frame mounted illumination device using light emitting diodes

(71) Applicant: Murari Sharma, Gaithersburg, MD (US)

(72) Inventor: Murari Sharma, Gaithersburg, MD (US)

(21) Appl. No.: 13/815,289

(22) Filed: Feb. 19, 2013

(51) Int. Cl. F21S 4/00; F21V 33/00

(52) U.S. Cl. CPC F21S 4/008; F21V 33/0032
USPC 362/183; 362/191; 362/222

(57) ABSTRACT

A picture illuminating device for mounting on the wall above the picture, or on the back of the picture frame. The device utilizes a light emitting diode (LED) or array of LEDs or light tube with LEDs to produce uniform lighting and is powered by conventional or rechargeable batteries which eliminates the requirement of electrical outlets and the spectacle of exposed electrical cords extending down the wall. The device is composed of a stem and a shade. The shade houses the LED or array of LEDs or light tube with LEDs, batteries and the electronic circuit that converts the direct current from the batteries to the current required to power the LED or array of LEDs or light tube with LEDs. The shade may or may not include a reflector which is configured to mount the LED or array of LEDs or light tube with LEDs and batteries so that the shade covers the LED or array of LEDs or light tube with LEDs adequately to prevent any glare from the front while presenting the look of a conventional, corded picture lamp.

### BACKGROUND OF THE INVENTION

The present invention relates to an illuminating device used for lighting artwork such as paintings, photographs, tapestries, or for lighting bookcases or walls. More particularly, the present invention is a LED or array of LEDs or light tube with LEDs lamp that is powered by batteries. The present invention is comprised of two distinct parts: a) a shade that houses batteries, a circuit needed to convert the dc power from the batteries to the power required to power a LED or array of LEDs or light tube with LEDs, said LED or array of LEDs or light tube with LEDs being placed inside a reflector. The shade is designed to completely cover the LED or array of LEDs or light tube with LEDs from the front so that the light shines on the artwork without causing a glare in the eye of the person viewing the picture; and b) a bracket, that can either be attached at one end to the artwork or to the wall behind or above the artwork, the other end being attached to the shade so that the shade can be adjusted to illuminate the artwork from the front. Preferably, the bracket allows for the shade to be adjustable relative to the artwork in a lateral fashion to adjust the distance from the artwork to the shade, and also including a swivel to allow the shade to be adjusted to a proper angle. Heretofore, varied picture lamps have been proposed, including on that use fluorescent tubes or LEDs to attain a more uniform lighting of the picture and to cast a light whose color attributes are closer to the color attributes of natural sunlight than from an incandescent light. An LED or array of LEDs or light tube with LEDs are also advantageous in that they illuminate the picture or artwork using an efficient lighting source that produces very little heat compared to incandescent lighting, thus being much less harmful to the artwork than the incandescent lights exemplified by U.S. Pat. No. 3,475,603 (Gheno); U.S. Pat. No. 3,723,720 (Schmidt); U.S. Pat. No. 3,786,245 and (Cincotta); U.S. Pat. No. D312,703 (Muller).

An LED picture lamp is exemplified by U.S. Pat. No. 7,066,619 (Waters), however, this patent essentially places the LED array directly vertically under the batteries does not invoke the part of claim 1 of the present invention of “said means for mounting said LED or array of LEDs or light tube with LEDs light tube being positioned within said shade relative to said source of direct current so that a plane which contains the mid-section of said source of direct current and the mid-section of said LED or array of LEDs or light tube with LEDs light tube makes an angle of at least ten degrees but not more than one hundred and seventy degrees, in either a clockwise or counter-clockwise direction with the vertical plane.” Also, the same shade does not house the said batteries as well as the LED or array of LEDs or light tube with LEDs light tube in one housing, as does the present invention.

Other picture lamps have also been proposed that are battery operated, such as the “Picture Light With Remote” and the “House of Troy BSLED14-51 Battery Operated Slim-Line LED Picture Light”, (both listed under “Other Publications” in the Information Disclosure Statement”) however, these house the batteries in a separate box and not in the shade as proposed in the present invention.

The inventor has also been granted a patent for a wall mounted picture lamp that uses batteries, (see U.S. Pat. No. 5,934,787 (Sharma)) which is entirely different in that it invokes the use of a fluorescent tube.

The present invention has the flexibility of being easily mounted either on the wall or on the picture frame, at the discretion of the user, after the user has assessed the type of wall and picture frame in question. The present invention also describes a means by which the LED or array of LEDs or light tube with LEDs, in relation to the batteries, is located in a general horizontal direction rather than a vertical direction. This aspect of the invention is entirely new in that none of the prior art describes such an arrangement of batteries to LED or array of LEDs or light tube with LEDs. The advantage of this arrangement is that the LED or array of LEDs or light tube with LEDs can be recessed further into the housing, so that it causes no glare when viewed from the front, and causes minimal reflective glare from the picture surface, while at the same time provides for a minimal vertical profile to the shade when viewed from the front, so as to cause the least distraction from the picture to be viewed.

It is an object of the present invention to provide a picture lamp having a low profile which provides even illumination of artwork while providing very little heat on the same, and is efficiently powered by conventional or rechargeable batteries, and can be easily mounted. It is also an object of the present invention to provide a picture lamp that illuminates artwork in the color temperature that is close to sunlight and lights the picture in closer to the same kind of color temperature it was painted in and was intended to be viewed. Another object of the present invention is to provide a picture lamp that alternatively mounts to a wall above a picture, or to the back of a picture frame. The installation can be accomplished with ease requiring only screws that are anchored into a wall or picture frame using a screwdriver.

It is a further object of the present invention to provide a picture lamp that is easy to manufacture and operate. Yet another object of the present invention is to provide a picture lamp where user replaceable parts, namely the batteries and the LED or array of LEDs or light tube with LEDs, are readily available at low cost. Both the batteries and the LED or array of LEDs or light tube with LEDs tube are readily and inexpensively available at hardware and other stores.

One more object of the present invention is to provide a picture lamp where the user replaceable parts, namely the batteries are easily replaced by the user, without the need for any tools. This is achieved by using an end cap on the end of the shade of the lamp that is easily removable to expel/replace the batteries. The end cap may include a spring contact to provide a connection for either the positive or negative end of the batteries. Alternatively, the batteries could be accessed through a door in the assembly.

Yet another object of the present invention is to provide a picture lamp where the shade contains both the batteries and the fluorescent light tube, where the shade covers the LED or array of LEDs or light tube with LEDs from the front so that no direct light from the fluorescent light tube is emanated towards the front (away from the picture). Further, for a picture lamp, the light from the reflection from the picture (usually covered by glass, adding to the reflection) needs to be minimized. This can be done by recessing the LED or array of LEDs or light tube with LEDs inside the shade adequately. Because of the abovementioned fact that a picture light should distract as little as possible from the picture it is lighting, it is advantageous to design the shade such that it presents the least possible vertical dimension when viewed from the front, while still recessing the LED or array of LEDs or light tube with LEDs as much as possible to avoid glare and reflection.

It is also an object of the present invention to allow the LED or array of LEDs or light tube with LEDs to be maximally recessed into the shade while the shade presents the least vertical dimension when viewed from the front. This is achieved by arranging the batteries and LED or array of LEDs or light tube with LEDs horizontally with respect to each other, rather than vertically. One method of achieving a non-vertical arrangement for the batteries and the LED or array of LEDs or light tube with LEDs within the shade is to use a “question-mark” shaped reflector to mount the batteries and the LED or array of LEDs or light tube with LEDs within the shade and position the LED or array of LEDs or light tube with LEDs at a location, with respect to the batteries, of other than a vertical plane through the midsection of the batteries and the LED or array of LEDs or light tube with LEDs, (if the batteries were placed directly above the LED or array of LEDs or light tube with LEDs) as depicted in the description of the preferred embodiment. Configurations other than a “question-marked” shape for a reflector may also achieve the same objects, for example by the use of an “L” shaped reflector where the sockets and fluorescent light tube are mounted on the vertical portion of the “L”.

Other objects of the invention may include:

Use of a remote control with the invention for the on-off function.
Use of a remote control with the invention for the on-off and the dimming function.

In many cases, it may be desirable to add a plastic or glass covering over the L.E.D.s to correct the color or to diffuse the light. If the present device is used as a picture light, and the picture had a glass covering, the L.E.D.'s tend to reflect as little dots, yielding a poor aesthetical result. Therefore, it is advantageous to cover the light with a diffused covering. Further, it is even more advantageous to produce a device that offers a choice in whether to have the L.E.D.s without a covering (where no light is lost due to the diffusion on the glass or plastic), or to have a diffused or colored covering.

For a permanent diffusion or color correction, a simple flat or curved or semicircular covering could be put over the L.E.D.s. If the aim is to offer a choice between not having a covering or not, the simple flat, or curved or semicircular covering could be constructed to “snap” or otherwise be temporarily or at choice be installed over the L.E.D.s. The flat, curved or semicircular covering could be offered along with the product, letting the user choose whether to install it or not.

Another method would be to use a circular tube that extends all the way round (360 degrees) over the led or led strip. The tube could be clear, adding to the aesthetics of the device by looking like a fluorescent lamp, while protecting the L.E.D. s.

The tube could be colored or diffused, which would permanently add the coloring or diffusing effect to the device. Lastly, the tube could be half-diffused and half-clear, giving the user the choice of having a diffused cover or not, by simply being able to turn the tube.

Another variation of the preferred embodiment would be from the positioning of the L.E.D.'s. For example, picture lights typically light a picture more at the top than at the bottom. The L.E.D.'s could be positioned such that some are aimed more towards the top of the item to be illuminated while some are aimed lower. Another example would be that the angle of the L.E.D. s at the endpoints of an L.E.D. array could be to angle the outermost ones more towards the left and right compared to the middle L.E.D.s, providing for a wider horizontal coverage of light on the item to be illuminated. The positioning of the L.E.D.s could be achieved in different ways, such as by molding the substrate for the “array” in different shapes, or by introducing beveled footings under the L.E.D.s to angle them correctly.

Another variation of the above would be to use L.E.D.s with a wider diffusion on the endpoints as compared to the L.E.D.s in the middle. These could also be positioned at an angle to further disperse the light in a horizontal manner. The objects of the invention are achieved by the provision of a picture lamp which is comprised of a bracket, and a shade that houses the conventional or rechargeable batteries; LED or array of LEDs or light tube with LEDs and the electronic circuit that converts the direct current from the batteries to current required to power a LED or array of LEDs or light tube with LEDs. The shade is attached to the bracket in a manner that positions the lamp at an angle whereby hanging artwork can be illuminated.

### BRIEF DESCRIPTION OF THE DRAWINGS

FIG. 1 is an exploded perspective view of the picture lamp.

FIG. 2 is a side view depicting the lamp with the end cap removed.

FIG. 3 is a side view of the lamp showing a method for mounting it to the wall.

FIG. 4 is a side view of the lamp showing a method for mounting it to the back of a picture frame.

FIG. 5 is a circuit diagram of the picture lamp.

FIG. 6a is a side view of the picture lamp showing the arrangement of the LED or array of LEDs or light tube with LEDs to the power source in the prior art.

FIG. 6b is a side view of the present invention, showing the arrangement of the LED or array of LEDs or light tube with LEDs to the power source with the fluorescent light tube being rotated around the power source in a clockwise direction from the position of the arrangement in the prior art.

FIG. 6c is a side view of the present invention, showing the arrangement of the LED or array of LEDs or light tube with LEDs to the power source with the LED or array of LEDs or light tube with LEDs being rotated around the power source in a counter-clockwise direction from the position of the arrangement in the prior art.

FIG. 7 is a side view of the present invention, showing the arrangement using an “L” shaped reflector.

FIG. 8a is a perspective view of the method of inserting an light emitting diode array on a substrate into a tube.

FIG. 8b is a perspective view of insertion of a partial diffused or tinted film into the tube to achieve a tube where either a clear emanation of the light or an emanation through the film can occur.

### DESCRIPTION OF THE PREFERRED EMBODIMENT

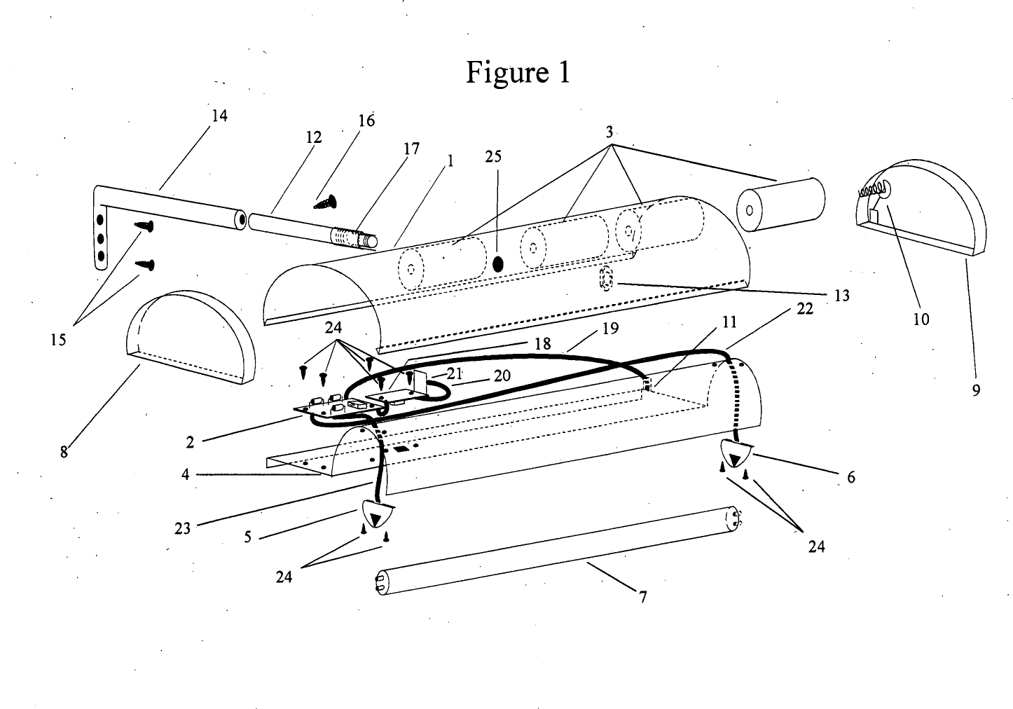

Referring to FIG. 1, the picture lamp consists of a shade 1 of generally semi-tubular shape that houses the circuit 2 and batteries 3, a question mark shaped reflector 4 having a straight planar portion connected to a curved portion, the straight portion being designed to provide a hollow opening between the wall of the shade 1 and the straight portion, allowing for installation of batteries 3 and the mounting of the circuit 2 in the said hollow opening. The curved portion of the reflector 4 acts to hold in place the sockets 5, 6 required to hold and allow to be easily changeable, the LED or array of LEDs or light tube with LEDs 7. The shade 1 is enclosed on the ends by two end caps 8, 9; with one of the end caps 9 allowing for contact with either the positive or negative contact of the battery power, through the use of a spring 10 and a metal contact 11. The shade 1, the reflector 4 and the end caps 8,9 are made of a resilient material which may be stamped, extruded or molded. The shade 1 is attached to a stem 12 by the use of a nut 13 on the inside of the shade 1. The stem 12 fits through the shade 1 through a hole 25 in the shade 1. The stem 12 fits into the mounting bracket 14, and mounting bracket 14 is in turn mounted to a wall or the back of a picture frame by the use of screws 15. The stem 12 mates to the mounting bracket 14 in a manner that allows it to be adjustably positioned with respect to the mounting surface. A set screw 16 may be used to lock the stem 12 and shade 1 at the desired distance from a surface 28. The shade 1 can be further positioned for an optimum angle of light delivery to a surface by adjustment of swivel adjustment 17 on the stem 12 using a universal tilt mechanism. The stem 12 and the mounting bracket 14 may be made of stamped, extruded or molded material. The picture lamp is operated by a switch 18, of on-off type, the switch may also include the function of being able to dim the LED or array of LEDs or light tube with LEDs. A separate switch may also be included for the dimming function. The positive and negative current bearing wires 19, lead from the respective positive and negative ends of the batteries from the contacts 11, 21 to the positive and negative inputs of the circuit 2, the positive wire 19 or 20 leading through the switch 18. Two wires 22, 23 lead from the outputs of the circuit 2, are guided through the reflector 4, and are connected to the two sockets 5, 6 that hold and provide electrical contact to the fluorescent light tube 7. These sockets 5, 6 are also instrumental in providing a means for replaceability of the fluorescent light tube 7. The sockets 5,6, switch 18, circuit 2 and contacts 11 can be mounted on the reflector by the use of screws 24. The end caps 8, 9 can be removed or mounted on the shade 1 by squeezing the shade 1 and sliding the end caps 8, 9 on or off the shade 1. The resilience of the shade 1 will act to hold the end caps 8, 9 in place.

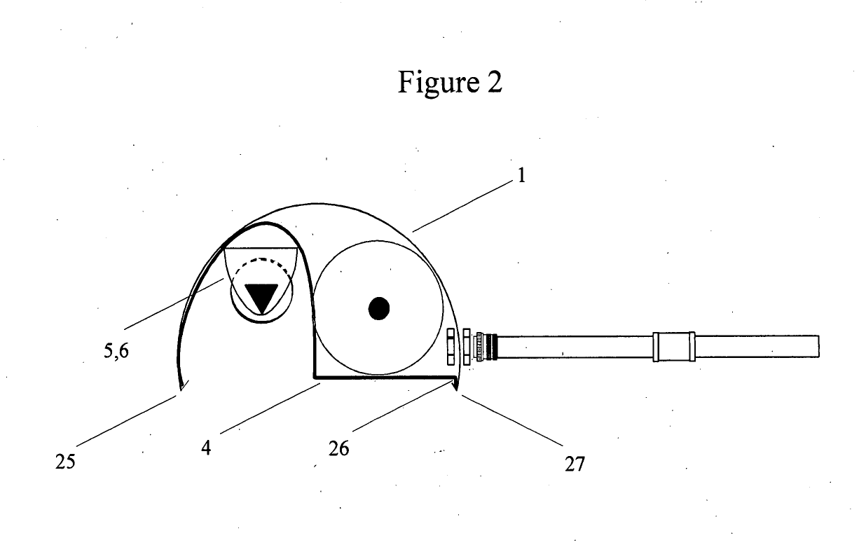

Referring to FIG. 2, The reflector 4 can be bent at a right angle along one edge 26 to hold itself in place within the shade 1, which has a corresponding bend 27 to receive said reflector 4. The reflector has its other edge received in a second bend 25 formed in the corresponding edge of the shade 1. The batteries 3 can be placed in the opening created between the shade 1 and the reflector 4. The reflector 4 also holds in place the sockets 5,6 that provides the contact and means of interchangeability for the fluorescent light tube 7. The sockets 5,6 can be attached to the reflector 4 by screws 24.

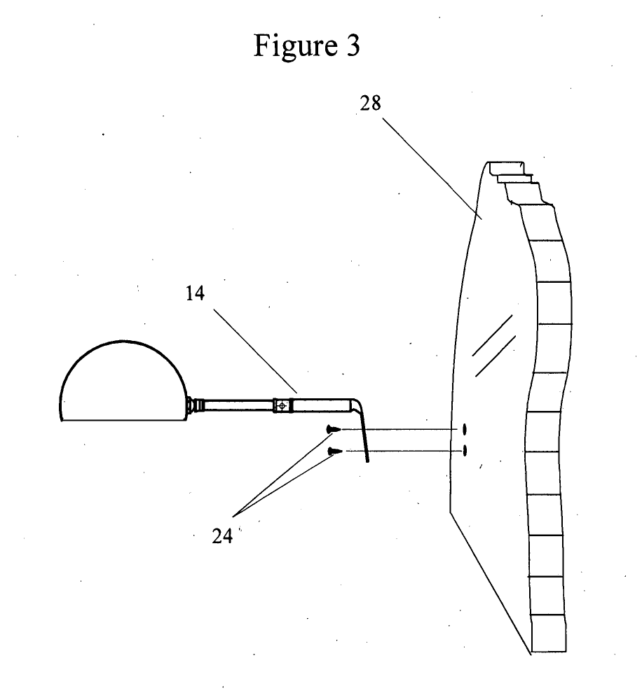

Referring to FIG. 3, the mounting bracket 14 can be mounted to the wall 28 by the means of screws 24.

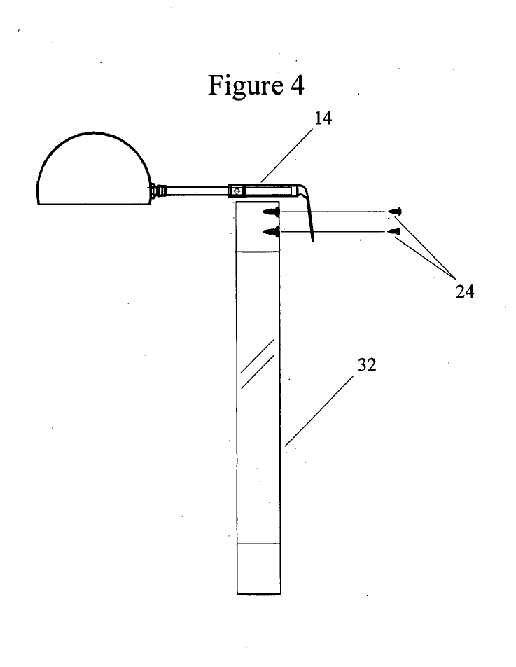

Referring to FIG. 4, the mounting bracket 14 can be mounted to the back of a picture frame 32 by means of screws 24.

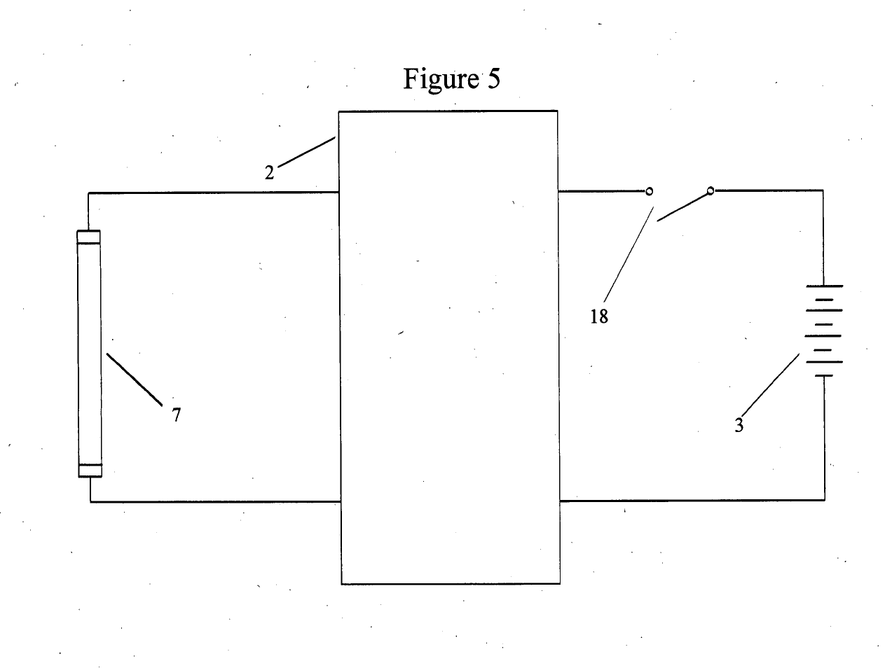

Referring to FIG. 5, the electrical circuit is comprised of a set of batteries 3 of conventional or rechargeable type where the positive output of the batteries 3 is connected to the switch 18. From the switch 18 is a connection to the positive input on the circuit 2. The outputs of the circuit 2 leads to the LED or array of LEDs or light tube with LEDs 7. The outputs of the circuit 2 may also lead to only one side of the LED or array of LEDs or light tube with LEDs, or wherever inputs for the circuit leads are located, however FIG. 5 depicts them going to the two ends. The negative input of the circuit 10 is connected to the negative input of the batteries 3 to complete the circuit.

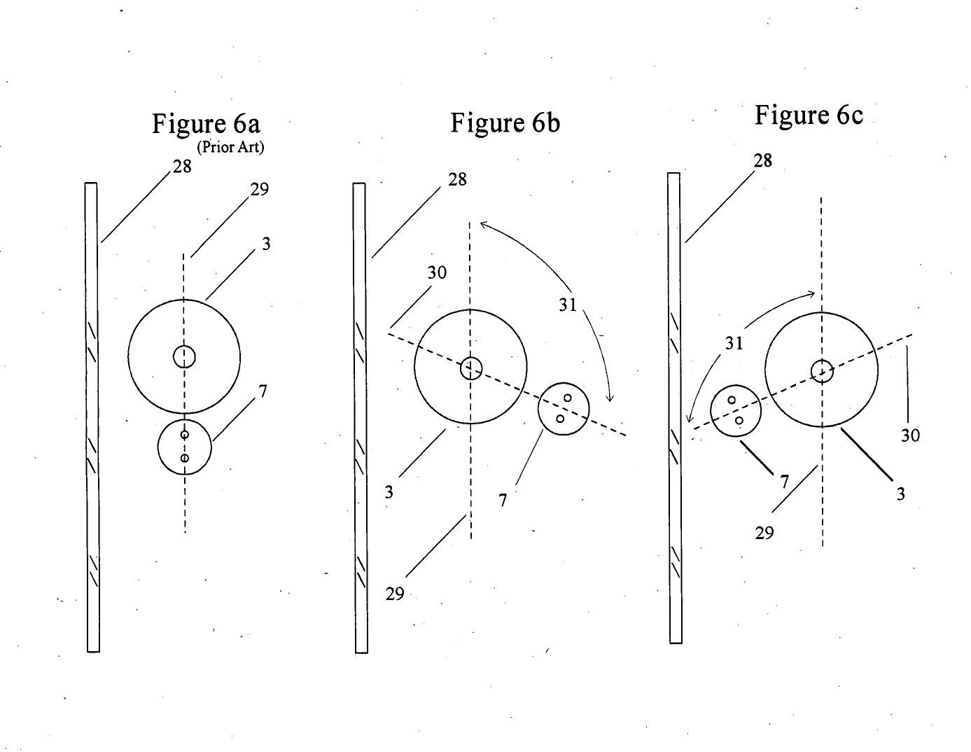

Referring to FIG. 6a, the battery 3 to LED or array of LEDs or light tube with LEDs 7 arrangement of the prior art is shown where a vertical wall 28 is depicted for reference of direction. The battery and fluorescent light tube are arranged with their respective axis in the vertical plane 29 through the midsections of the battery 3 and LED or array of LEDs or light tube with LEDs 7.

FIG. 6b, shows the battery 3 to LED or array of LEDs or light tube with LEDs 7 arrangement of the present invention where a vertical wall 28 is shown for reference of direction. The plane 30 goes through the midsections of the battery 3 and LED or array of LEDs or light tube with LEDs 7 forms an angle 31 with the vertical plane 29, which contains the midsection of the batteries, the LED or array of LEDs or light tube with LEDs 7 being moved around the battery 3 in a clockwise direction from the prior art position.

FIG. 6c, shows the battery 3 to LED or array of LEDs or light tube with LEDs 7 arrangement of the present invention where a vertical wall 28 is shown for reference of direction. The plane 30 goes through the midsections of the battery 3 and LED or array of LEDs or light tube with LEDs 7 forms an angle 31 with the vertical plane 29, which contains the midsection of the batteries, the LED or array of LEDs or light tube with LEDs 7 being moved around the battery 3 in a counter-clockwise direction from the prior art position.

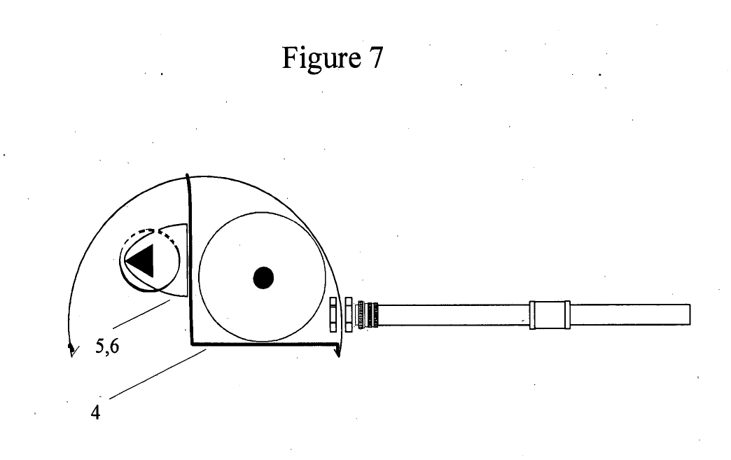

Referring to FIG. 7, The reflector 4 can be “L” shaped with the sockets 5,6 mounted on the vertical portion of the “L” shaped reflector 4.

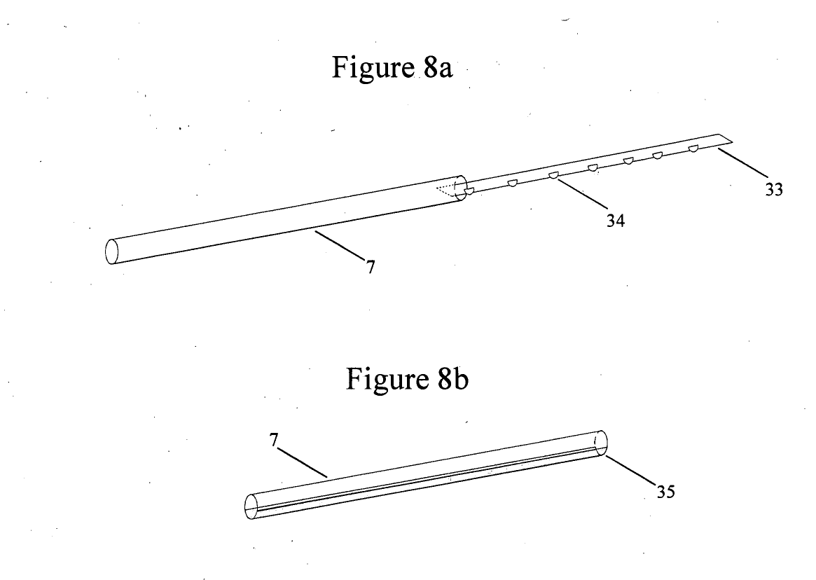

Referring to FIG. 8a, it shows the arrangement of a substrate 32 for LEDs 33 filling into a light tube 7

Referring to FIG. 8b, it shows light tube 7 with a shaded part 34, which could be a diffused part of the glass (or plastic) light tube 7, or a plastic diffused sheet either on the inside or outside of the light tube 7, or a tinted part of the light tube, or a plastic diffused sheet either on the inside or outside of the light tube 7.

From the foregoing description it should be apparent that the present invention provides many features that are entirely new in a battery operated, fluorescent picture lamp. The invention combines the efficiency of a LED or array of LEDs or light tube with LEDs with a DC power source, whereby the physical arrangement between the power source and the LED or array of LEDs or light tube with LEDs allows for a lamp made with a minimum vertical dimension. This allows for a larger power source to be used than would be practical with the power source to LED or array of LEDs or light tube with LEDs arrangement of any of the prior art, thus allowing a longer battery life for the light, while allowing for the least obstruction of view of the art to be illuminated.

Obviously, the construction may be modified in some respects without departing from the spirit of the invention which is clearly spelled out in the claim. This could include other physical ways to house the LED or array of LEDs or light tube with LEDs and batteries in the desired configuration, such as a complete housing made of molded material, either painted on the outside surface or covered with a thin film of material of desired finish over the molded housing. Alternatively, the batteries may be housed in a tube that fits into the space between the reflector and shade, the tube providing ease of insertion or removal of the batteries. Another alternative would be to mount a battery holder on to the reflector, and sliding out the entire reflector assembly in order to access the batter holder for insertion or removal of the batteries. The use of a battery holder may obviate the need for a spring contact on the end cap, assuming a contact is integral to the battery holder.

The LED or array of LEDs or light tube with LEDs is similarly able to slide into appropriate sockets, and retained in the sockets by simply twisting the fluorescent light tube. Other means may be used for inserting and removing the batteries may also be used, such as the inclusion of a “door” at the bottom of the flat portion of the reflector, obviating the need for removing the end caps for the purpose of inserting or removing batteries. The entire invention can be constructed of stamped, extruded or molded material and is provided with all of the features for placement necessary to illuminate hanging artwork.

What I claim is:

1. A wall or picture frame mounted, cordless illuminating device comprising: a tubular stem having a first end and a second end; a mounting bracket being formed with a first and second part; said first part adjustably receiving said first end of said tubular stem and said second part being removably mounted to a picture frame or a wall; and an elongated shade having a mid-section adjustably mounted to said second end of said tubular stem; said shade having a semicircular cross-section; said shade houses means for removably mounting at least one fluorescent light tube and a source of direct current on either side of a vertical plane cut through the ends of the semicircular shade, said shade further housing an electronic circuit for converting direct current from the power source to the appropriate current needed for powering the LED or array of LEDs or light tube with LEDs, said means for mounting said LED or array of LEDs or light tube with LEDs light tube being positioned within said shade relative to said source of direct current so that a plane which contains the mid-section of said source of direct current and the mid-section of said LED or array of LEDs or light tube with LEDs light tube makes an angle of at least ten degrees but not more than one hundred and seventy degrees, in either a clockwise or counter-clockwise direction with the vertical plane.

2. The wall or picture frame mounted, cordless illuminating device of claim 1 wherein said shade further includes: an elongated reflector having an arcuate portion and a planar portion which together have a generally question marked (?) shaped cross-sectional configuration, or the elongated reflector having an “L” shaped cross-sectional configuration; said reflector defines an enclosed space to house the means of direct current and an open space within said arcuate portion for said means for mounting said LED or array of LEDs or light tube with LEDs.

3. The wall or picture frame mounted, cordless illuminating device of claim 1 combined with a remote control.

4. The wall or picture frame mounted, cordless illuminating device of claim 1 combined with a dimming capability.

5. The wall or picture frame mounted, cordless illuminating device of claim 1 combined with remote control and dimming capability.

6. The wall or picture frame mounted, cordless illuminating device of claim 1 combined with the use of a tube over the LED or LED array, said tube being clear, frosted, partially frosted or progressively frosted or tinted.

7. The wall or picture frame mounted, cordless illuminating device of claim 1 combined with the use of a led array substrate wherein the LED's may be angled to different degrees.

8. The wall or picture frame mounted, cordless illuminating device of claim 2 combined with a remote control for the on-off function.

9. The wall or picture frame mounted, cordless illuminating device of claim 2 combined with a dimming capability.

10. The wall or picture frame mounted, cordless illuminating device of claim 2 combined with remote control for the on-off function and dimming capability.

11. The wall or picture frame mounted, cordless illuminating device of claim 2 combined with the use of a tube over the LED or LED array, said tube being clear, frosted, partially frosted or progressively frosted or tinted.

12. The wall or picture frame mounted, cordless illuminating device of claim 2 combined with the use of a led array substrate wherein the LED's may be angled to different degrees.

13. The wall or picture frame mounted, cordless illuminating device of claim 2 wherein the reflector is formed with a unitary construction.

14. The wall or picture frame mounted, cordless, illuminating device of claim 1 wherein the planar portion of the reflector includes a surface for mounting a holder for retaining the source of direct current and for mounting said electronic circuit.

15. The wall or picture frame mounted, cordless, illuminating device of claim 2 wherein the planar portion of the reflector includes a surface for mounting a holder for retaining the source of direct current and for mounting said electronic circuit.

16. The wall or picture frame mounted, cordless, illuminating device of claim 1 wherein the source of direct current is a plurality of conventional batteries.

17. The wall or picture frame mounted, cordless, illuminating device of claim 2 wherein the source of direct current is a plurality of conventional batteries.

18. The wall or picture frame mounted, cordless, illuminating device of claim 1 wherein the source of direct current is a plurality of rechargeable batteries.

19. The wall or picture frame mounted, cordless, illuminating device of claim 2 wherein the source of direct current is a plurality of rechargeable batteries.

20. The wall or picture frame mounted, cordless, illuminating device of claim 1 wherein the stem is adjustably mounted to the shade by a universal tilt mechanism.

21. The wall or picture frame mounted, cordless, illuminating device of claim 1 wherein said axis of said elongate shade extends parallel to an upper edge of said upper edge of said picture frame.
